(19) United States
(12) Patent Application Publication
(10) Pub. No.: US 2023/0180375 A1
(43) Pub. Date: Jun. 8, 2023

(54) CONTROL METHODS IN NETWORKED LIGHTING SYSTEMS

(71) Applicant: LED Smart Inc., Surrey (CA)

(72) Inventor: Xinxin Shan, Surrey (CA)

(21) Appl. No.: 17/720,207

(22) Filed: Apr. 13, 2022

(30) Foreign Application Priority Data
Nov. 4, 2021 (CA) 3137589

(51) Int. Cl. H05B 47/185; H05B 47/19; G06K 7/14; H04L 67/025

(52) U.S. Cl. CPC H05B 47/185; H05B 47/19; G06K 7/1417; H04L 67/025

(57) ABSTRACT

A networked lighting system includes a control center and one or more devices controlled by the control center. The control center communicates with the one or more devices using a wired bus-structured communications network. The control center communicates with the devices in a master/slave mode where the devices send signals only in response to messages from the control center. The control center may use packets including device identification information to address individual devices. In order to initialize the network, the devices may have machine-readable identification tags to provide the identification information, the control center being operatively connected to a reader for reading the machine-readable identification tags and sending the identification information to the control center.

### TECHNICAL FIELD

The present invention generally relates to initial networking methods and signal packet transmission methods in a networked lighting system.

### BACKGROUND

In some application fields, the lighting control signals cannot be wireless signals. For example, in military and transportation industry fields, wireless control may be prohibited. In this case, power line communication (PLC) technology or traditionally RS-485 (using extra two wires) communication technology can be used to transmit the lighting control signals and sensor information.

These two types of communication technologies use a bus structure to transmit signals. Limited channels (in some cases only a single channel) may be available. In these circumstances, signal collisions, and signal confusion in individual or group controls are two difficult issues.

### SUMMARY

There is provided a networked lighting system including a control center and one or more devices to be controlled by the control center. A wired bus-structured communication network connects the control center and the devices. The one or more devices each include a respective machine-readable identification tag, and the networked lighting system includes a reader for reading the respective machine-readable identification tags, the reader being operatively connected to the control center to send to the control center identification information on the devices obtained by reading the respective machine-readable identification tags, the control center being configured to use the identification information to initiate communications to the one or more devices. The one or more devices are configured to interact with the control center in a master/slave mode in which the control center acts as the master and the devices as the slaves, the master sending messages over the wired bus-structured communication network and each slave sending signals over the wired bus-type communication network only in response to the messages from the master.

In various embodiments, there may be included any one or more of the following features: the machine-readable identification tags may be RFID tags and the reader may be an RFID scanner. The machine-readable identification tags may be QR codes and the reader may be a QR code™ reader. The QR code™ reader may be a mobile device which wireles sly connects to the control center. The QR code™ reader may be a video camera connected to the control center via a wired connection. The machine-readable identification tags may be bar codes and the reader may be a bar code reader. The wired bus structured communication network may be an RS-485 network. The wired bus structured communication network may be a power line communication network. The control center may be configured to include in a message of the messages an error detection code. The control center may be configured to include, in a message of the messages, address information indicating one or more of the one or more devices as addressed by the message, and message identification information identifying the message. The address information may include respective identification codes for one or more of the one or more devices. The address information may include respective group identification codes for one or more groups of devices, each group corresponding to one or more of the one or more devices. The control center may be configured to, in the event of not receiving from the devices a reply to a message of the messages sent by the control center, resend the message after a randomized period of time. There may be one or more additional control centers connected to the wired bus-structured communication network. The wired bus-structured communication network connecting the control center and the devices may be one of plural wired bus-structured communication networks connecting the control center and the devices. The plural wired bus-structured communication networks may be implemented on different respective wires. The plural wired bus-structured communication networks are implemented on respective logical channels on a common wire. The control center may be configured to assign priority levels to the messages, and may be configured to select a wired bus-structured communication network of the plural wired bus-structured communication networks over which to transmit a message of the messages based on the priority level of the message. The one or more devices may be a subset of a larger number of devices and different networks of the plural wired bus-structured networks may connect the control center to different subsets of the larger number of devices.

There is also provided a control center for controlling a networked lighting system, the control center being connected to a wired bus-structured communication network and configured to control one or more devices, via the wired bus structured communication network, in a master/slave mode in which the control center acts as the master and the devices as the slaves, the master sending messages over the wired bus-structured communication network and each slave sending signals over the wired bus-type communication network only in response to the messages from the master, each device of the one or more devices including a respective embedded micro-controller and a respective machine-readable identification tag, the control center also being configured to connect to a reader for reading the respective machine-readable identification tags, to receive from the reader information on the devices obtained by reading the respective machine-readable identification tags, and being configured to use the information to initiate communications to the one or more devices.

These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a schematic diagram showing a networked lighting system.

FIG. 2 is a flow chart showing an exemplary method of initializing a network of a networked lighting system.

FIG. 3 is a flow chart showing another exemplary method of initializing a network of a networked lighting system.

FIG. 4 is a schematic diagram showing exemplary contents of a packet sent in a network of a networked lighting system.

FIG. 5 is a schematic diagram showing an exemplary signal and response timeline in a network of a networked lighting system.

FIG. 6 is a schematic diagram showing an exemplary signal and response timeline for a network of a networked lighting system in the event that a recipient device does not initially respond to a command signal.

FIG. 7 is a schematic diagram showing an exemplary signal and response timeline for a network of a networked lighting system in the event that two control centers send colliding command signals.

### DETAILED DESCRIPTION

Immaterial modifications may be made to the embodiments described here without departing from what is covered by the claims.

In this document, the term “wired bus-structured communications network” is used to refer to any wired network with a single collision domain such that simultaneous transmissions will collide with one another. Such a network may include a single wire, but a network comprising different wires linked by one or more repeaters to form a single collision domain is also a wired bus-structured communications network. In a single wire with multiple channels such that the different channels form separate collision domains, each such channel is here considered to be a wired bus-structured communications network if it is organized as a network, with responses to messages on a channel (network) typically using the same channel, and with the possibility that multiple devices may use the same channel contemplated. A wired bus-structured communications network may include a linear structure, but is not limited to networks with a linear structure.

Examples of a wired bus-structured communications network include power line communication (PLC) technology or RS-485. These two types of network can also be combined into a single hybrid network. The network may include one or more nodes to convert packets from one communication method to the other. For example, in order to control the lights in two separated greenhouses together, a farmer may use RS-485 networks in both greenhouses connected by a PLC network, with RS-485/PLC bridge nodes linking each RS-485 network segment to the PLC network to form the hybrid network.

To address the issues of signal collisions and signal confusion on a wired bus-structured communications network, a method is provided in which a strict master-slave architecture is followed. The control center acts as the master and all other devices, for example lights and sensors, act as the slaves. The master can send out command or inquiry to the slaves when it needs. A slave can only send out a signal when the master asks it to do so. The control center may need to differently control different devices on the network. In order to supply such different control, the control center needs to have information on the different devices and to send messages that will be treated differently by the different devices. To accomplish this different control, it is proposed to supply each device with identification information (ID). The control center knows the ID of each device, and all the commands and responses may contain the ID of the device addressed by the command or from which the response is sent. The signal package of command or inquiry from the master or the reply signal package from the slave may contain, for example, command/reply type, slave ID, message ID (for example sequence number), data length, data, and error detection (e.g. Cyclic Redundancy Check (CRC) fields.

The ID may be programmed (e.g. by software or hardcoding) into each device when manufactured. In order to conveniently provide the control box (master) with the ID, it is proposed to use a machine-readable identification tag, for example a QR code™ or Radio-Frequency Identification (RFID), corresponding to the programmed ID information. The use of the term this document refers to a readable information-containing structure and does not imply, for example, that the tag is a separate structure from the rest of the device (for example, a QR code™ could be implemented as a pattern of shading directly on a housing of a device). A QR code™ may also be implemented, for example, as a sticker on a housing of a device. The machine-readable identification tag is read by a reader, for example a QR code™ reader or RFID reader, connected to the control center to send the ID to the control center. The information on the tag may also include additional information, such as a type of the device (e.g. type of sensor or light). Type information may also be obtained, for example, by a lookup from a server, depending on the embodiment.

The tag reader may be operated by a human during this process. The process may be overseen by the same or a different human using a user interface (UI), for example on a smart phone. In some embodiments, the tag reader may also be a smart phone, and if both the tag reader and the UI are on smart phones, they may be the same smart phone or different smart phones. Depending on the embodiment, the human overseeing the process may have the opportunity to associate additional information to a device during this process using the UI. For example, the human could manually enter information on the location or purpose of the device, to be displayed in the UI. The same or a different human may then use the UI to instruct the control center to operate the device in a particular manner, using the human-readable manually entered information to identify the device, which the control center then translates into the ID in order to send commands to the particular device.

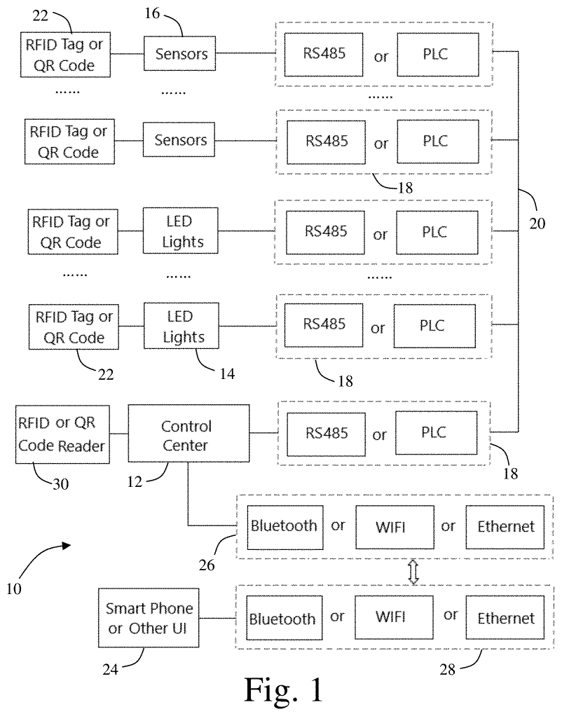

Referring to FIG. 1, a diagram of a networked lighting system 10 is shown. The networked lighting system 10 includes at least one control center 12 and one or more devices, for example lights 14, sensors 16 or other devices including accessories.

There are one or more network interfaces 18 in each light 14 or sensor 16 or control center 10 or other devices. These allow the control center and devices to communicate over a wired bus-structured communications network 20, which can for example be an RS-485 or powerline communication (PLC) network as shown. Each device can include a respective micro-controller (not shown).

There may be a machine-readable identification tag 22, such as for example an RFID tag or QR code™ as shown, on each of the light 14 or sensor 16 or other device. The QR code™ can also be replaced with a bar code. The machine-readable identification tag contains a unique ID recorded at manufacturing time. This ID is also programmed into the light or sensor at the manufacturing time so that at normal working time, the light or sensor only accepts signal packages bearing the same ID and its response signal packages contains the ID as well.

A user may use a display device 24 such as a smart phone, or a pad, or a computer terminal to connect to the control center. The display device 24 may connect to the control center by any suitable means; in the example shown using a network interface 26 in the control center and a corresponding network interface 28 in the display device, which may for example communicate using Bluetooth™, Wi-Fi™ or Ethernet as shown. A user app running in the smart phone, or the pad, or the control center can operate a user interface (UI) on the display device 24 and allow the user to configure the control center via the UI.

There may be a reader 30 for reading the machine-readable identification tags 22. In the example embodiment shown the reader 30 is shown directly connected to the control center 12. The reader 30 may be for example an RFID scanner, or a QR code™ reader. The reader 30 may be used to scan/read the identification information and report it to the control center 12. Depending on the embodiment, the reader 30 may be connected to the control center 12 in other ways, including for example the reader 30 and the display device 24 being a single smart phone or multiple smart phones.

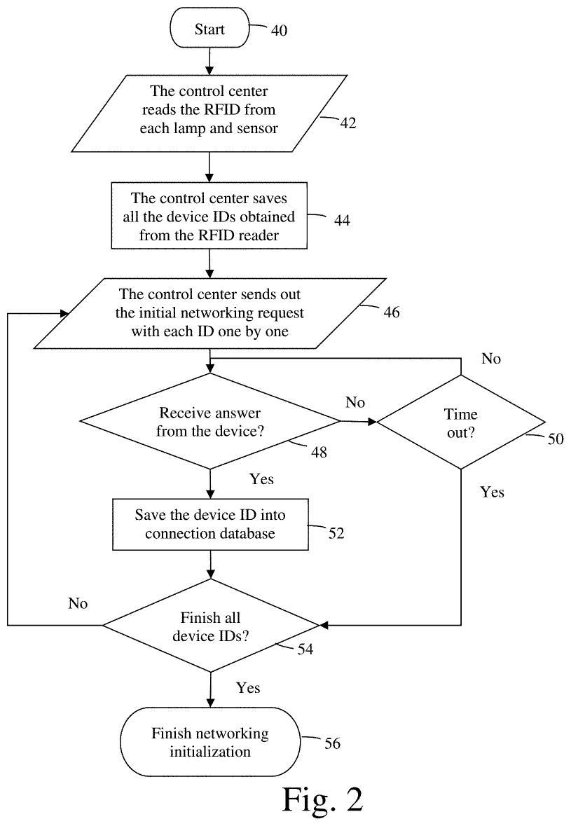

FIG. 2 is a flow chart that shows a method that may be used by a control center receiving identification information, e.g. by scanning of RFID tags, relating to devices in the lighting system. In the method shown in FIG. 2, the tag reader 30 shown in FIG. 1 may be integrated into the control center, for example as a stationary device to which the devices are presented before installation. In another embodiment, the control center including the tag reader may be movable in order to scan the tag of each device. The control center may include a wired power connection and may be powered by batteries or super capacitors, for example in order to keep the control center powered when moved in an embodiment in which the control center is movable, in addition to or instead of the wired power connection. The tag reader may also be a movable device which is linked to the control center by a wired or wireless connection. From start 40, the scanner portion of the control center, or other tag reader, scans or otherwise reads the tags one by one in step 42. The IDs of each scanned device are saved into the control center in step 44. Later, the commands to any light/sensor will bear this ID. The control center may, for example in response to a command from the user, conduct verification that the devices are connected to the network in steps 46-54. In step 46 the control center sends out an initial networking request with each ID one by one. In step 48, if an answer is not received, the control center waits in step 50 for a timeout period. If an answer is received in step 48, the control center saves the device ID in a connection database in step 52. In step 54, the control center proceeds to send the initial networking request to the next device, or if all devices have been saved to the connection database or timed out, the control center proceeds to finish networking initialization in step 56.

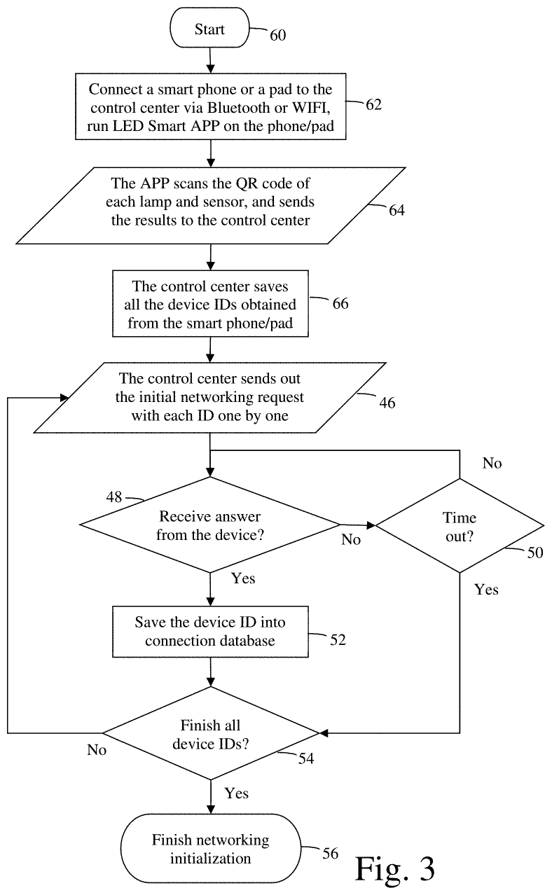

FIG. 3 is a flow chart showing another method that may be used by a control center receiving identification information relating to devices in the lighting system. In the method shown in FIG. 3, the tag reader 30 shown in FIG. 1 is a separate device from the control center, for example a smart phone or pad or computer terminal. From start 60, in step 62 of FIG. 3 the tag reader connects to the control center, for example using Bluetooth™ or Wi-Fi™. In step 64 the tag reader reads the tags of the devices, e.g. by scanning a QR code™ on each light/sensor, to obtain its device ID. The tag reader may have installed software, such as an app provided by LED Smart™, with instructions to carry out step 64 of the method of FIG. 3. The IDs are sent to the control center, which saves them in step 66. The remaining steps 46-56 shown in FIG. 3 are in an embodiment the same as the corresponding steps of FIG. 2. The smart phone/pad/computer terminal can be replaced with a video camera, either attached to the control center, or as an external plug and play device. The lights and sensors should be scanned with this video camera before installing. Such a camera may be used with the method shown in FIG. 2. In an embodiment, the QR codes can be replaced with bar codes, and a video device may be configured to recognize the IDs from the bar codes, or a laser bar code scanner may be used.

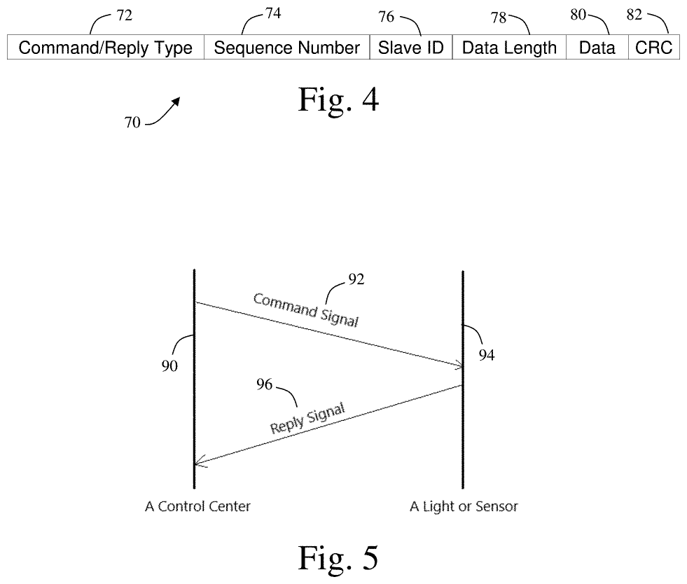

FIG. 4 shows an example general signal packet format for a packet 70. The packet shown is a packet sent by the control center to a device. Each packet in the embodiment shown contains fields for the signal type 72, message identification information 74 (for example, sequence number of the packet 70), identification 76 for the device transmitted to (here shown as slave ID), data length 78, data 80, and error correction (e.g. CRC field) 82. The reply packet from the light/sensor may also contain the same sequence number and slave ID. Hence the control center knows what a reply packet is an answer to. More or fewer and differently arranged fields may be used.

The control center can send out signals to group some of the lights/sensors. In this case, the slave ID in a signal package can be replaced with a group ID for the multiple lights/sensors. The group ID may, for example, relate to a group selected by the user and saved by the control center and also by the devices. The control center may send a message or messages to the devices of the group to instruct them to store the group ID. Such a group ID may be shorter than an original device ID since it only needs to be unique among groups in the same network, whereas a device ID may need to be unique among all devices sold. In an embodiment the control center may therefore generate and distribute group IDs for individual devices, allowing the control center to communicate with the devices without using the full device IDs.

FIG. 5 illustrates a normal command/reply messaging procedure where there is a single control center sending a message directed to a single device. The control center 90 sends a command signal packet 92 to all the devices on the bus. Only the device 94 with the same ID will reply to the signal packet. When the reply signal packet 96 reaches the control center 90, the control center will check the slave ID and sequence number to verify the reply signal is for its past commands.

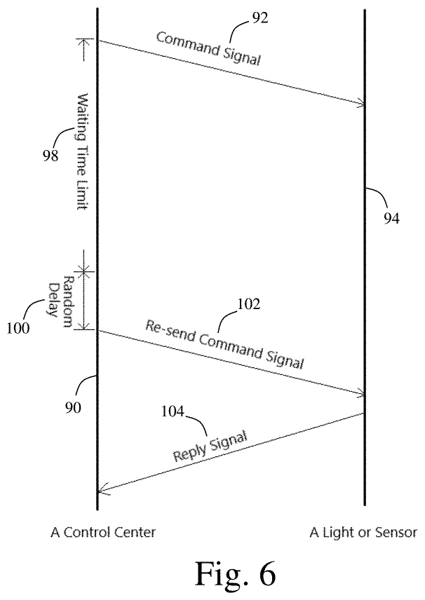

FIG. 6 illustrates a re-send messaging procedure where a device 94 does not respond to an initial message. A control center 90 sends a command signal packet 92 to all the devices on the bus. Within a certain time limit 98, the control center receives no reply. The control center may then wait a short random time 100 before re-sending the same packet, or an adjusted packet 102 (for example with a different sequence number). The re-sent packet 102 may receive a reply 104. The randomized time 100 may be for example selected from a discrete set of possible delays. Depending on the embodiment, repeated failures may lead to the time being selected from a set including larger possible delays. The control center may deem a message undeliverable if no transmission succeeds for a specified time or number of attempts.

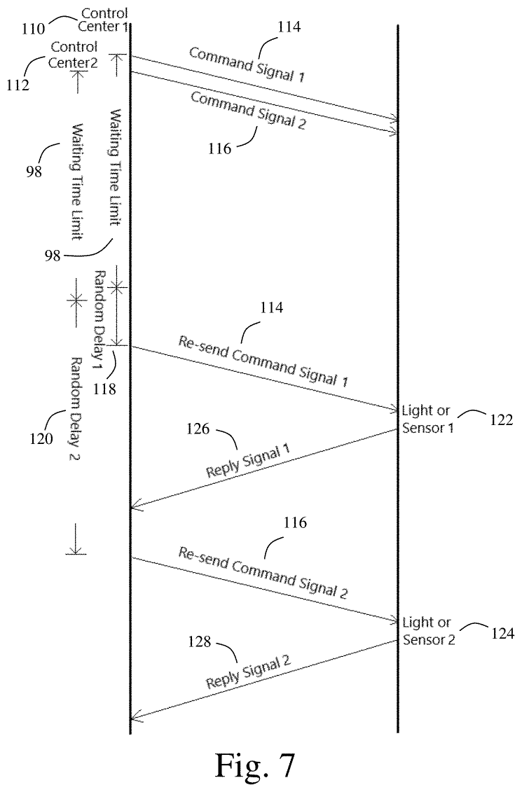

FIG. 7 shows a collision and re-send messaging procedure with two control centers 110 and 112. One control center 110 sends a command signal packet 114 to all the devices on the bus. At nearly the same time, another control center 112 sends another command signal packet 116. The two signal packets collide. When the corrupted packets reach the devices, they cannot get the CRC checking correctly. Hence no device replies. Within the time limit 98, the two control centers receive no reply. They then wait a short random time 118 and 120 respectively before each re-sends its same or modified packet. These additional packets reach their destinations 122 and 124 and get replies 126 and 128 respectively.

Multiple control centers may each communicate with their own respective device(s) over a common network, or some or all devices could be included in the control of multiple control centers.

A control center may also communicate with the devices using more than one bus structured communication network. Additional communication networks may use extra wires, but also could use additional logical channels on a single wire. The additional logical channels could be implemented for example using different carrier frequencies or different time slots. The different networks may be used to transmit different priority signals, or signals sent to different groups of devices. The control center may in some embodiments be a sub control center controlled by another control center over the wired bus-structured communications network or by other means. The control center/sub control center can be a control box, a control panel, or any other smart system.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A networked lighting system comprising:
a control center;
one or more devices to be controlled by the control center, the one or more devices each including a respective embedded micro-controller and a respective machine-readable identification tag;
a wired bus-structured communication network connecting the control center and the devices;
a reader for reading the respective machine-readable identification tags, the reader being operatively connected to the control center to send to the control center identification information on the devices obtained by reading the respective machine-readable identification tags, the control center being configured to use the identification information to initiate communications to the one or more devices;
the one or more devices being configured to interact with the control center in a master/slave mode in which the control center acts as a master and the devices as slaves, the control center sending messages over the wired bus-structured communication network and each device of the one or more devices sending signals over the wired bus-structured communication network only in response to the messages from the control center.

2. The networked lighting system of claim 1 in which the machine-readable identification tags are radio-frequency identification (“RFID”) tags and the reader is an RFID scanner.

3. The networked lighting system of claim 1 in which the machine-readable identification tags are quick response (“QR”) codes and the reader is a QR code™ reader.

4. The networked lighting system of claim 3 in which the QR code™ reader is a mobile device which wireles sly connects to the control center.

5. The networked lighting system of claim 3 in which the QR code™ reader is a video camera connected to the control center via a wired connection.

6. The networked lighting system of claim 1 in which the machine-readable identification tags are bar codes and the reader is a bar code reader.

7. The networked lighting system of claim 1 in which the wired bus structured communication network is an RS-485 network.

8. The networked lighting system of claim 1 in which the wired bus structured communication network is a power line communication network or a hybrid RS-485 plus power line communication network.

9. The networked lighting system of claim 1 in which the control center is configured to include in a message of the messages an error detection code.

10. The networked lighting system of claim 1 in which the control center is configured to include in a message of the messages:
address information indicating one or more of the one or more devices as addressed by the message; and
message identification information identifying the message.

11. The networked lighting system of claims 10 in which the address information includes respective identification codes for one or more of the one or more devices.

12. The networked lighting system of claim 10 in which the address information includes respective group identification codes for one or more groups of devices, each group corresponding to one or more of the one or more devices.

13. The networked lighting system of claim 1 in which the control center is configured to, in the event of not receiving from the devices a reply to a message of the messages sent by the control center, resend the message after a randomized period of time.

14. The networked lighting system of claim 13 further comprising one or more additional control centers connected to the wired bus-structured communication network.

15. The networked lighting system of claim 1 in which the wired bus-structured communication network connecting the control center and the devices is one of plural wired bus-structured communication networks connecting the control center and the devices.

16. The networked lighting system of claim 15 in which the plural wired bus-structured communication networks are implemented on different respective wires.

17. The networked lighting system of claim 15 in which the plural wired bus-structured communication networks are implemented on respective logical channels on a common wire.

18. The networked lighting system of claim 15 in which the control center is configured to assign priority levels to the messages, and is configured to select one of the plural wired bus-structured communication networks over which to transmit a message of the messages based on the priority level of the message.

19. The networked lighting system of claim 15 in which the one or more devices are a subset of a larger number of devices and different networks of the plural wired bus-structured communication networks connect the control center to different subsets of the larger number of devices.

20. A control center for controlling a networked lighting system, the control center being connected to a wired bus-structured communication network and configured to control one or more devices, via the wired bus-structured communication network, in a master/slave mode in which the control center acts as a master and the devices as slaves, the control center sending messages over the wired bus-structured communication network and each device of the oner or more devices sending signals over the wired bus-structured communication network only in response to the messages from the master control center, each device of the one or more devices including a respective embedded micro-controller and a respective machine-readable identification tag, the control center also being configured to connect to a reader for reading the respective machine-readable identification tags, to receive from the reader information on the devices obtained by reading the respective machine-readable identification tags, and being configured to use the information to initiate communications to the one or more devices.
